(19) United States
(12) Patent Application Publication
(10) Pub. No.: US 2006/0165321 A1
(43) Pub. Date: Jul. 27, 2006

(54) profiled guiding element

(76) Inventors: Peter Groche, Darmstadt (DE); Michael Jockel, Frankjeche-Crumbach (DE)

Correspondence Address: WHITE, REDWAY & BROWN LLP, 1217 KING STREET, ALEXANDRIA, VA, 22314, US

(21) Appl. No.: 10/528,650

(22) PCT Filed: Sep. 25, 2003
(86) PCT No.: PCT/DE03/03191

§ 371 Date: Oct. 5, 2005

(30) Foreign Application Priority Data
Sep. 25, 2002 (DE) 10244911.2

(51) Int. Cl. F16C 29/00

(52) U.S. Cl. 384/7

(57) ABSTRACT

The invention relates to a profiled guiding element consisting of sheet metal for longitudinal guiding operations or pivoting guiding operations, comprising at least one guiding surface embodied thereon. The invention is characterised in that the profiled guiding element (1, 1a, 1b, 1c, 1d, 1e, 1f, 1g, 1h, 1i) comprises two projecting edge flanges (4, 4a, 4b, 4c, 4d, 4c, 4f, 4g, 4h, 4i) on a longitudinal edge (3, 3a), which are formed by profiling gaps in the longitudinal edge (3, 3a). At least one surface (3, 3a, 5, 5a, 6, 6a, 6b, 6c, 7, 7a, 7b, 7c, 7d, 7e) of the profiled guiding element (1, 1a, 1b, 1c, 1d, 1e, 1f, 1g, 1h, 1i) forms a guiding surface for at least one rolling or sliding body (2, 2a, 2b, 15).

The invention relates to a profiled guiding element consisting of sheet metal for longitudinal guiding operations or pivoting guiding operations, comprising at least one guiding surface embodied thereon.

In many technical application areas, longitudinal guiding operations that can be embodied as rolling guiding operations or sliding guiding operations, as well as pivoting guiding operations, are required. Examples where longitudinal guiding operations are utilized are guiding operations for furniture drawers and seat runners in motor vehicles.

Longitudinally oriented profiled guiding elements used for this purpose are usually manufactured by roll forming to shape, extruding, using a bending press, or hot rolling, where the material being used and the size of the lot to be produced determine which manufacturing method is chosen. All of these known methods for manufacturing the profiled guiding elements have in common that only minimal or no reinforcement of the utilized material can be realized in the area on the surface of the manufactured parts. Depending on the application, therefore, costly post-processing measures such as thermal treatments or coating techniques must be performed subsequently, especially on the guiding surfaces, in order to enhance durability under operating conditions and resistance to wear.

Therefore, the task of the invention is to create a profiled guiding element of the type described in the introduction that exhibits on its at least one guiding surface an increased toughness and/or hardness without requiring post-processing steps, and that can be manufactured in a cost-effective manner.

This task is solved according to the invention by a profiled guiding element that comprises an one longitudinal edge two projecting edge flanges formed by profiting gaps in the longitudinal edge, and by having at least one surface of the profiled longitudinal edge form a guiding surface for at least one rolling body or sliding body.

More recent developments in metal-working technology have shown that by using a process known as “profiling gaps,” it is possible to manufacture profiled elements with edge flanges pointing away from the plane of the sheet metal (DE 100 39 768 A1—German patent application). This process uses a forming roller and two press rollers to shape a flat band of sheet metal into a longitudinally oriented profiled element. The resulting edge flanges formed by this process exhibit increased toughness and hardness, especially in the area where the work piece makes contact with the forming roller. With this process, it is possible to manufacture, at low cost, profiled guiding elements that withstand greater loads than currently obtainable profiled guiding elements do. The increased toughness and hardness in certain surface areas derived from this manufacturing process are exploited according to the invention in that at least one portion of these surface areas of increased toughness and hardness form guiding surfaces when the profiled element is used for longitudinal guiding operations or pivoting guiding operations.

An additional particular advantage is that the surface quality in those surface areas that were touching the forming rollers is especially good, making precisely those areas particularly well-suited as guiding surfaces due, among other things, to their surface quality.

Another advantage is that the guiding surfaces that work in different directions can be embodied by different edge flanges. Doing so makes it possible for decreased elastic rigidity to compensate for tolerance-related departures from the ideal geometry.

The profiled guiding elements can be manufactured compactly by profiling gaps and without taking up a lot of space. Because profiled guiding elements manufactured by profiling gaps are in one piece, economic and technical advantages are obtained in terms of the number of parts and the elimination of assembly operations. The geometries of the edge flanges can be designed at will and, thus, optimal geometries from the standpoint of the ability to withstand strain can be created. The intentional influencing of the edge flanges' rigidity, especially their thickness, enables the twisting or warping proclivities, for example when prestressing, of the longitudinal guiding operations or pivoting guiding operations that are produced to be adjusted and optimized.

The design of the profiled guiding elements according to the invention causes the size of the surface on the edges to be larger. This creates room for putting on drive components (which can also be integrated in the profiled guiding element), e.g. a steering rack, or sensors used, for example, to detect position.

A preferred embodiment of the invention provides for the surface area lying between the two edge flanges to form, at least in part, the guiding surface. When profiling gaps, this surface area has experienced a particularly high degree of hardening and surface smoothing, making it eminently well-suited as a guiding surface.

Alternatively, or in addition, it can also be provided for the guiding surfaces to be formed at least partially by the interior sides of the two edge flanges facing each other. These interior surfaces also exhibit, as a result of the manufacturing process, a considerably greater toughness and/or surface hardness as well as a high-quality surface.

Other advantageous embodiments of the concept of the invention are the object of additional subsidiary claims.

In the following, embodiment examples illustrated in the drawing are used to discuss the invention in greater detail.

Shown on each drawing in simplified cross-section are:

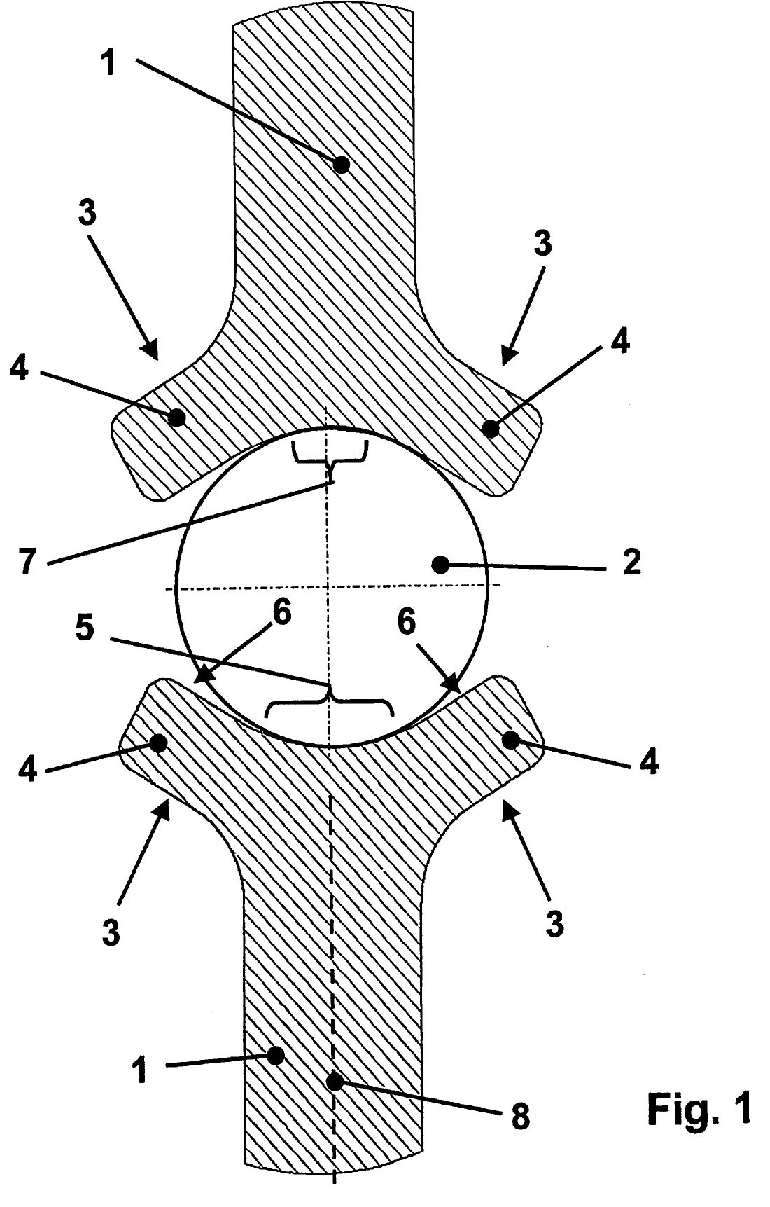

In FIG. 1, a longitudinal guiding operation embodied as a roller guiding operation with rolling bodies between two profiled guiding elements,

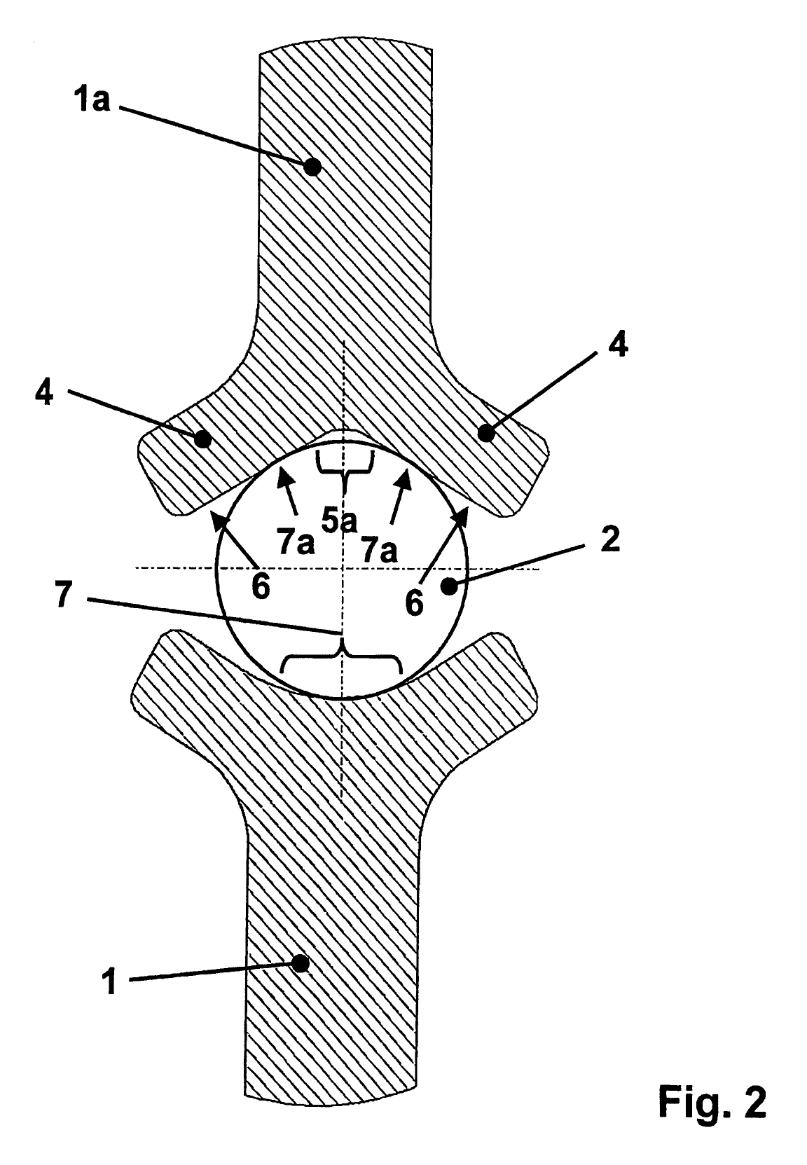

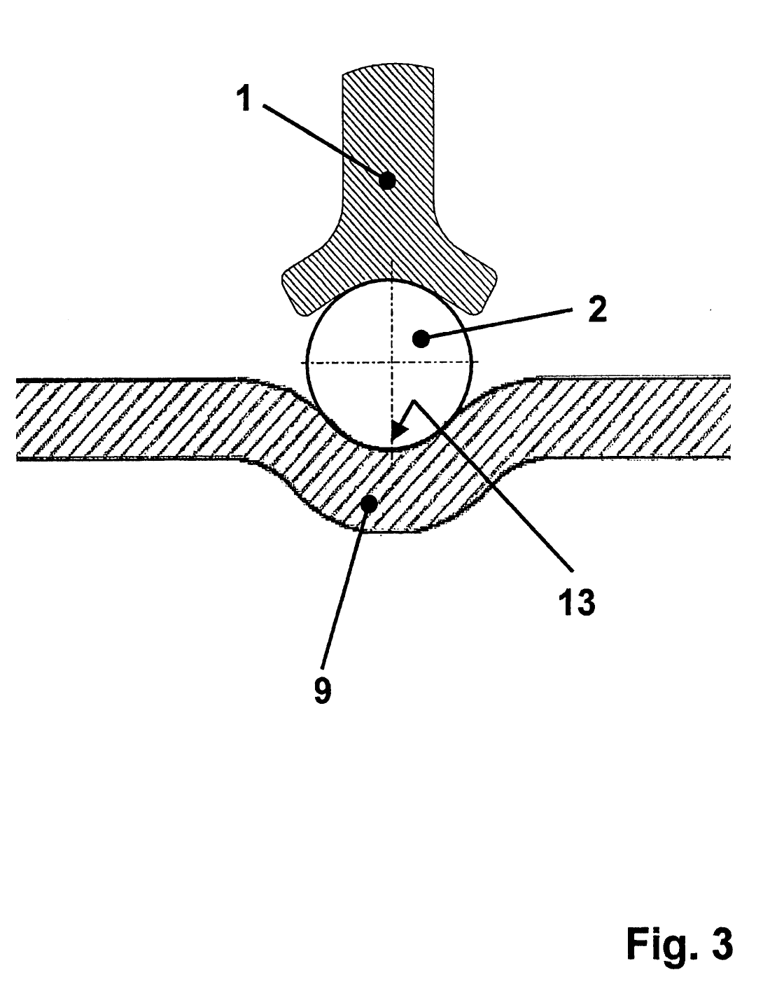

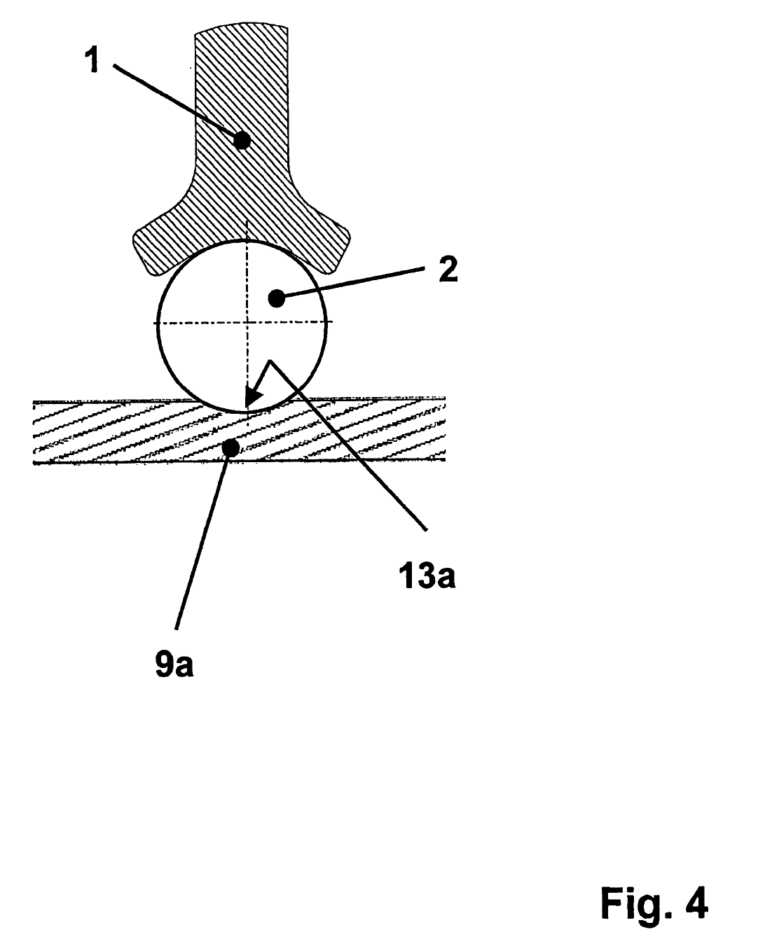

In each of FIG. 2, FIG. 3 and FIG. 4, a longitudinal guiding operation embodiment somewhat modified from FIG. 1,

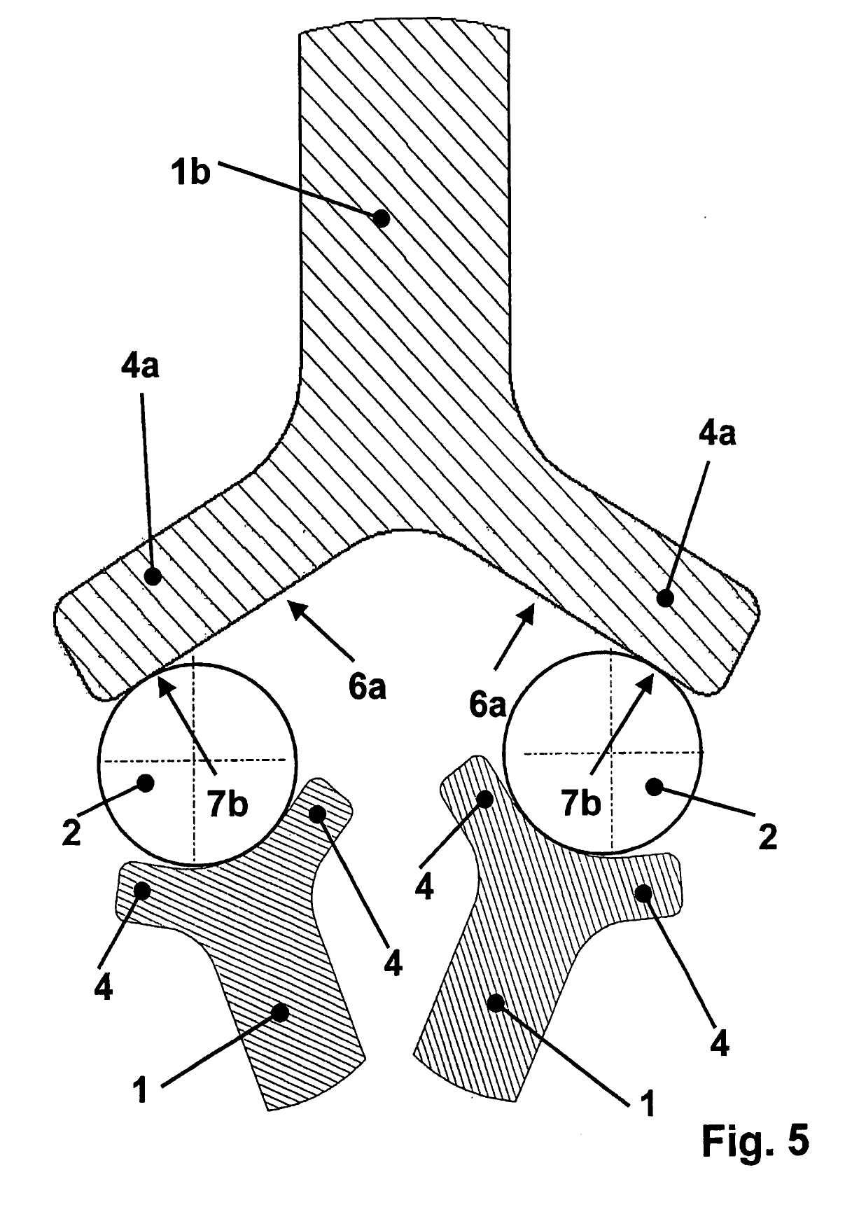

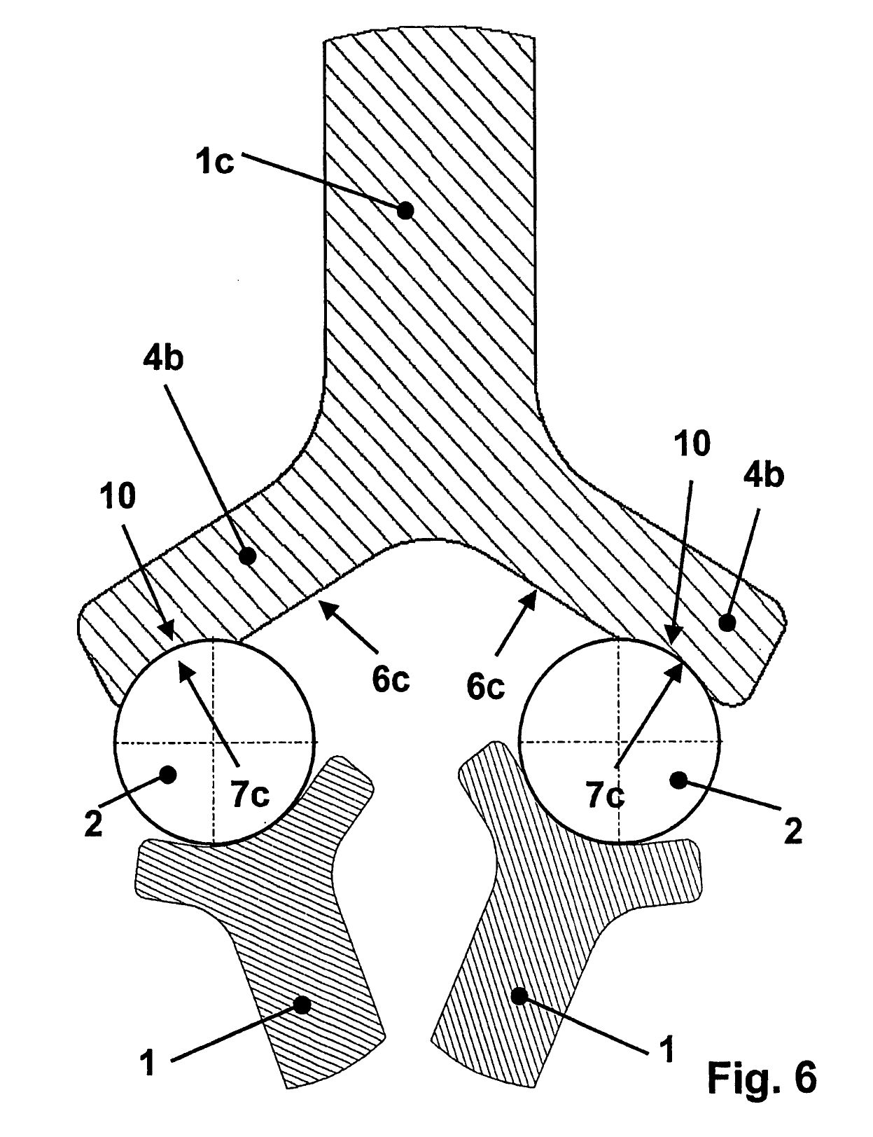

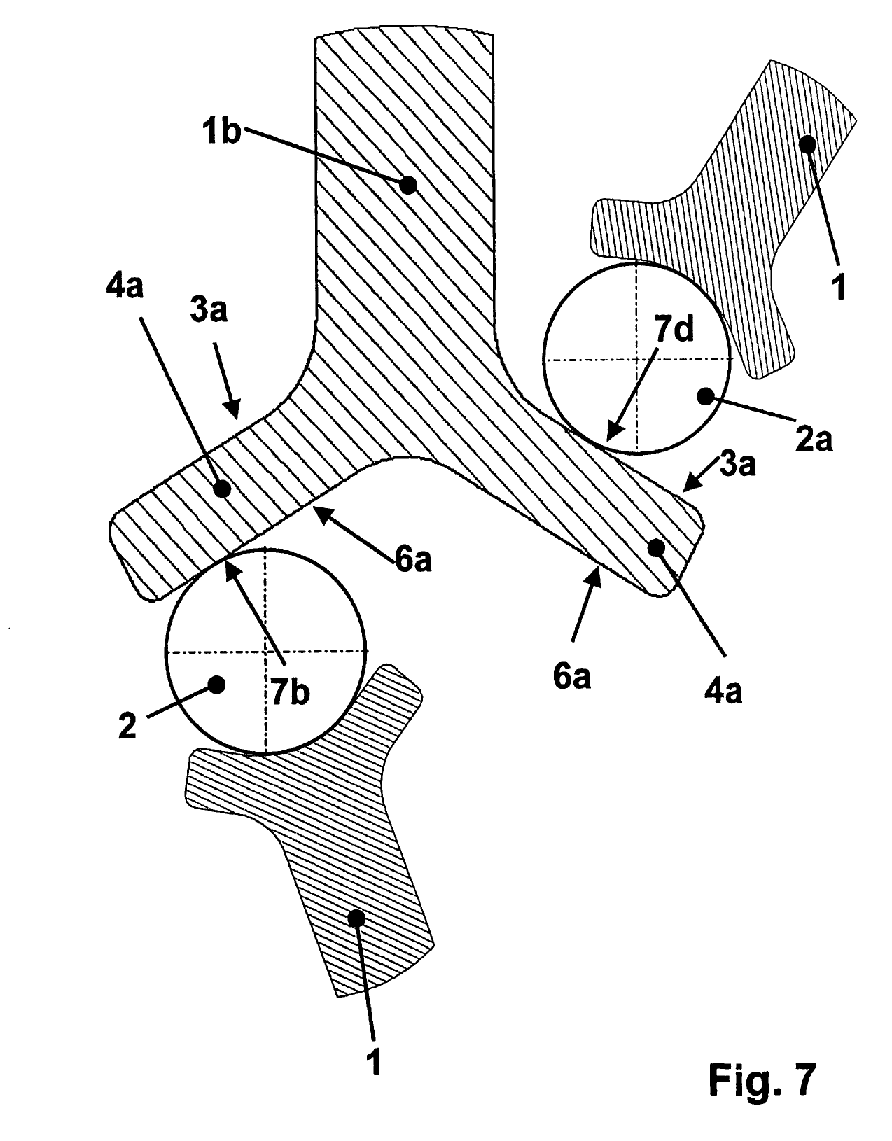

In each of FIG. 5, FIG. 6 and FIG. 7, a longitudinal guiding operations embodied as roller guiding operations with rolling bodies located between three profiled guiding elements,

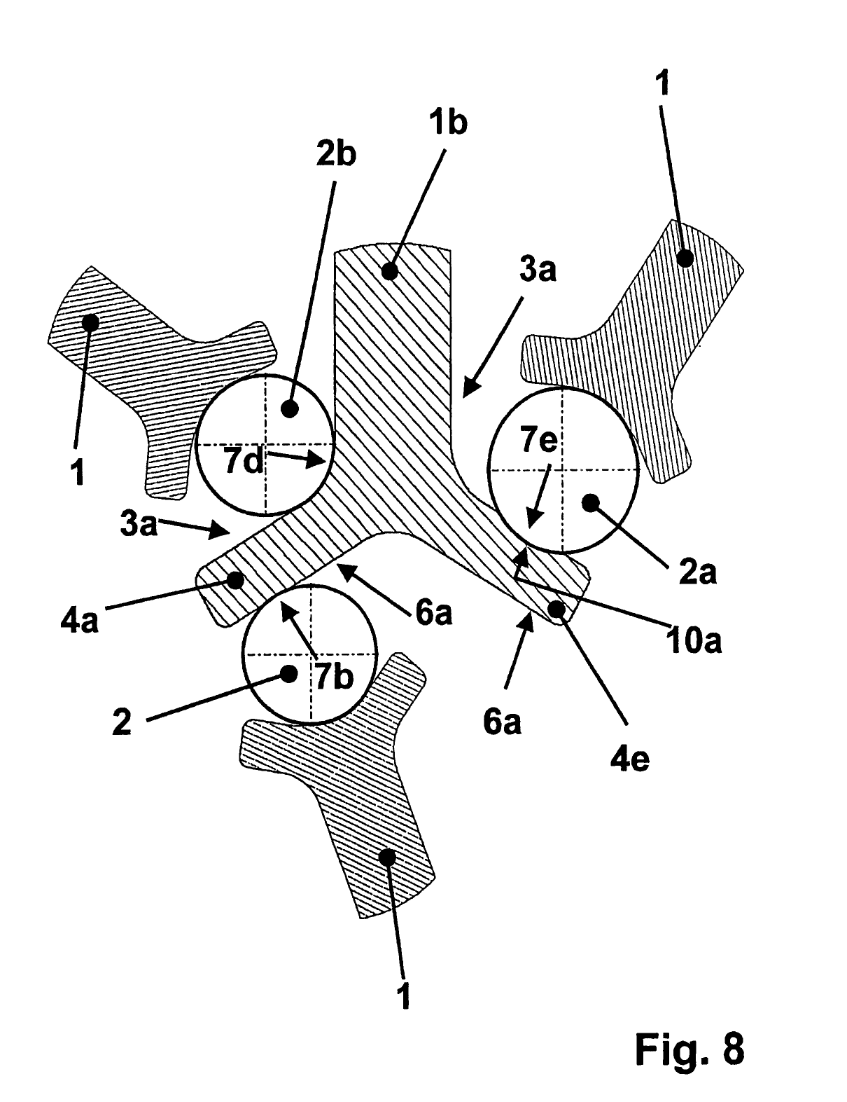

In FIG. 8, a longitudinal guiding operation embodied as roller guiding operations with rolling bodies located between four profiled guiding elements,

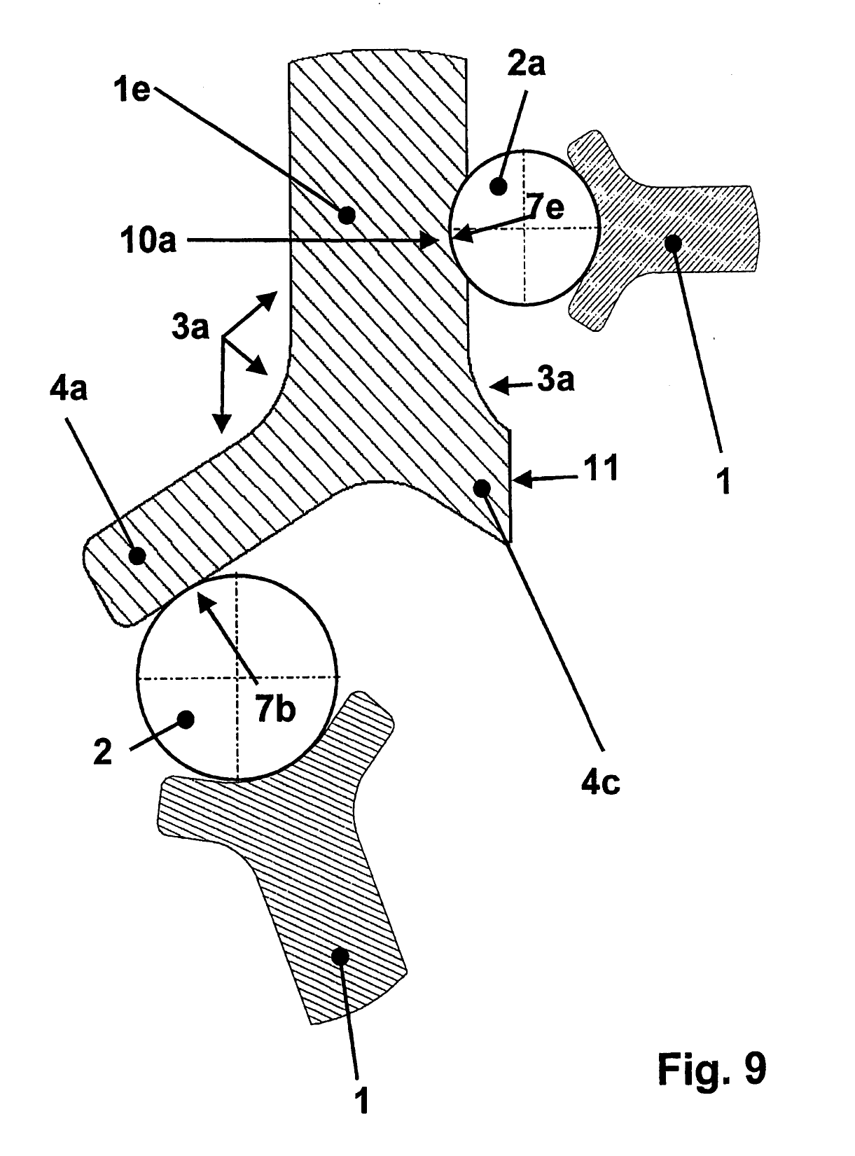

In FIG. 9, a longitudinal guiding operation embodied as a roller guiding operation with rolling bodies located between two profiled guiding elements, with one flange partially separated,

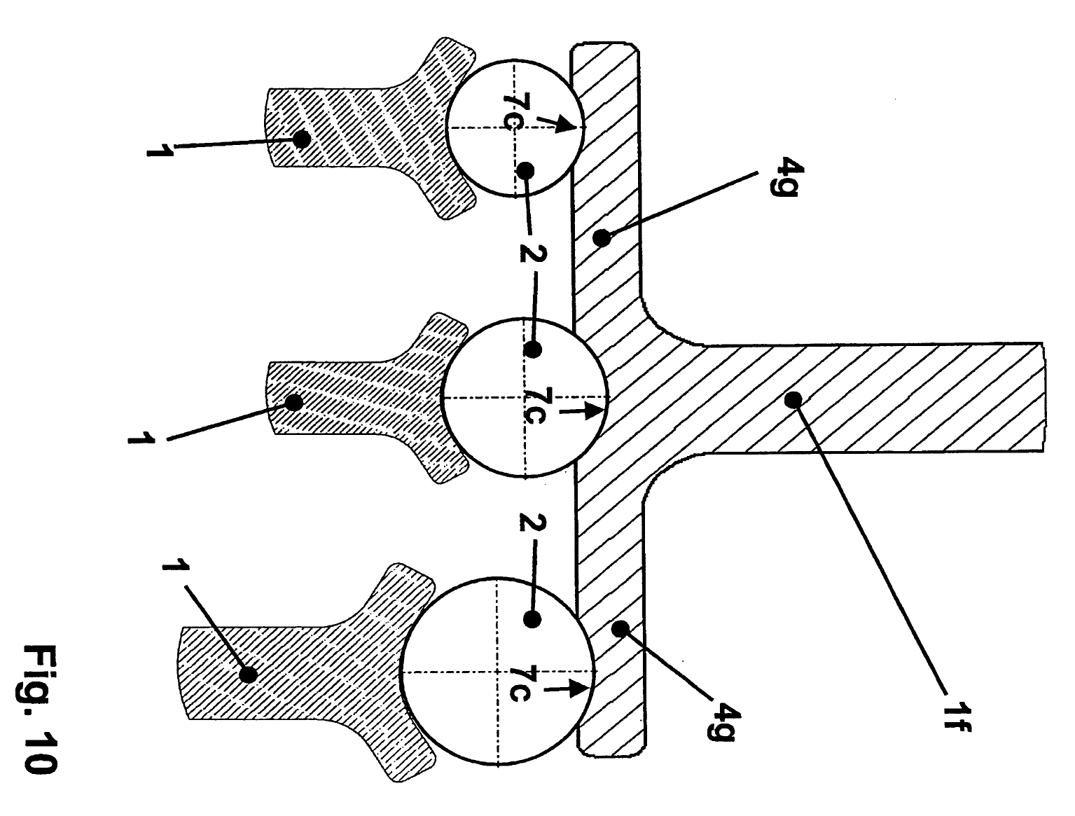

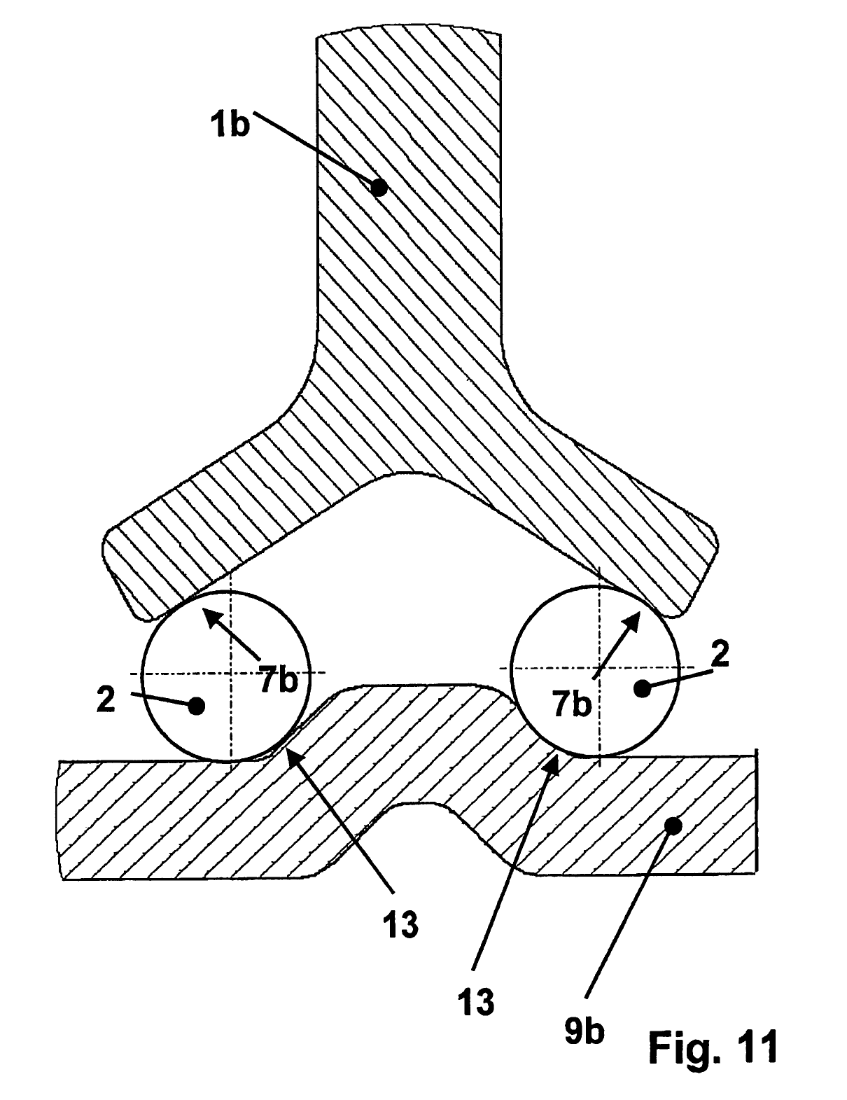

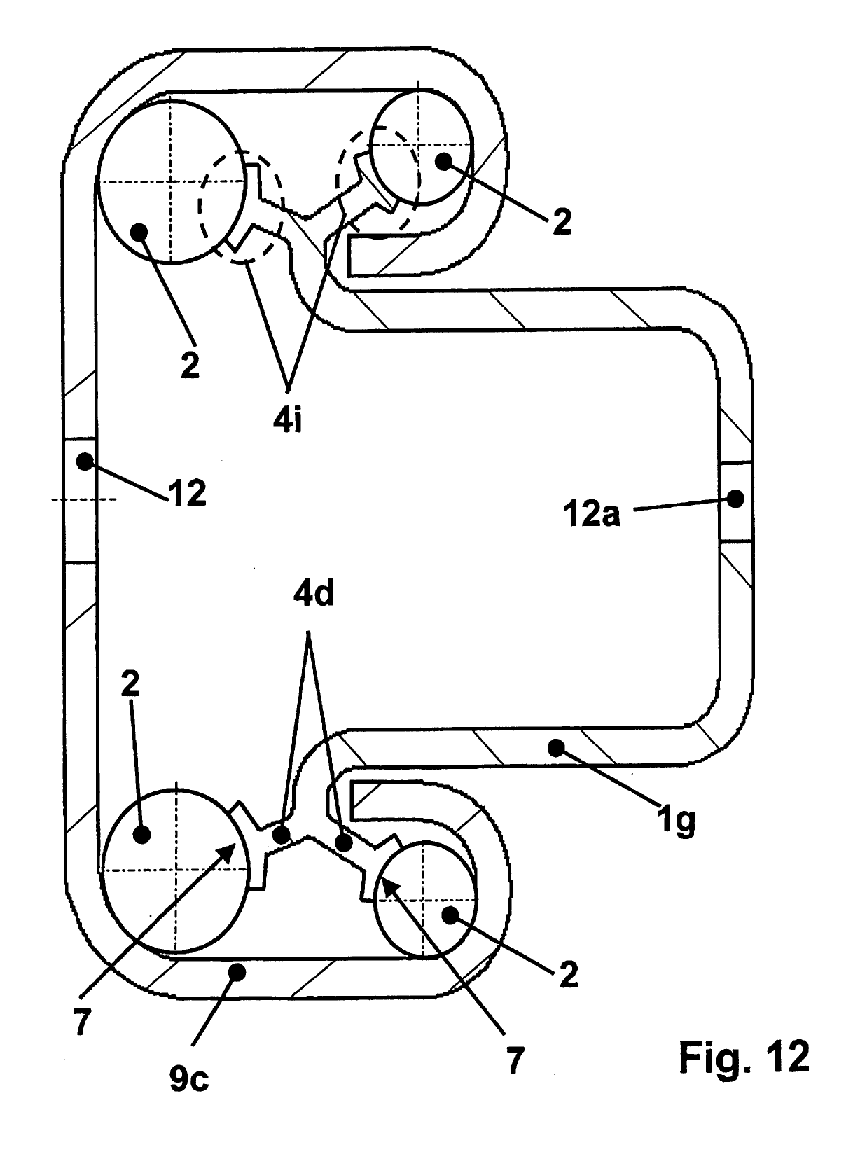

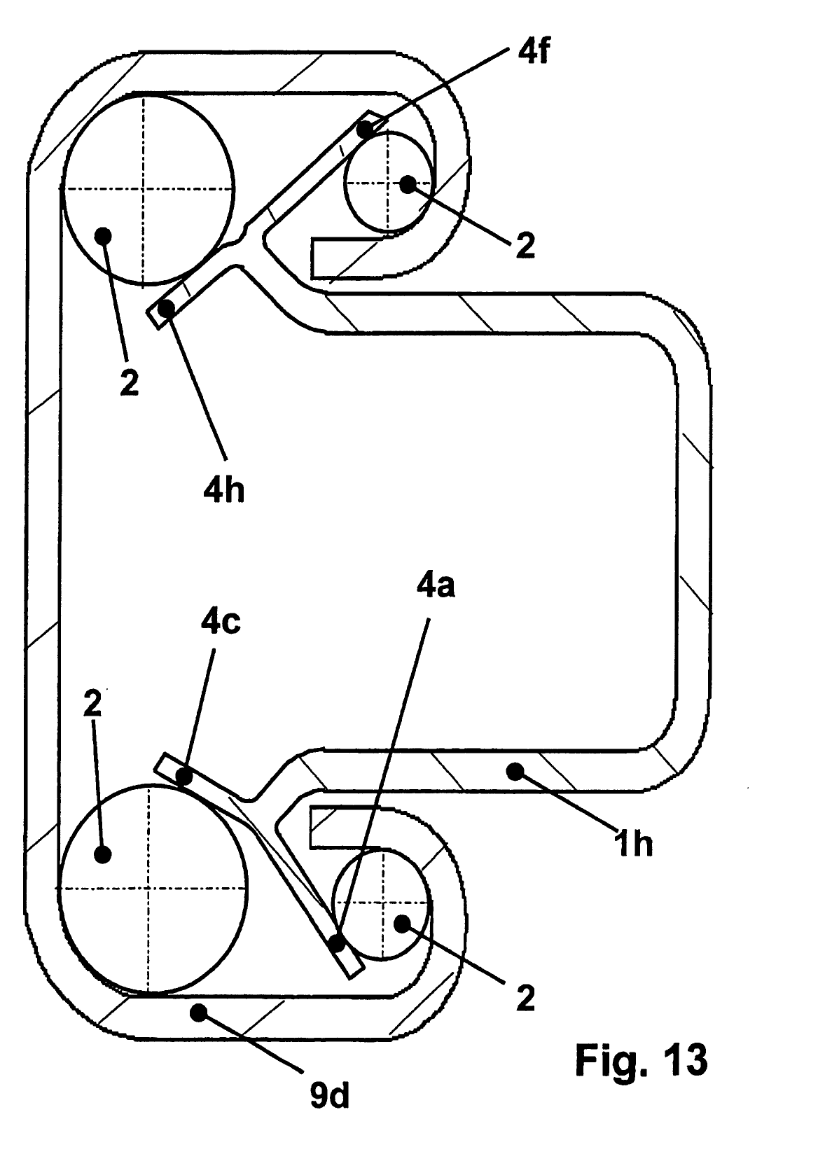

In each of FIG. 10, FIG. 11, FIG. 12 and FIG. 13, further modified embodiments of longitudinal guiding operations,

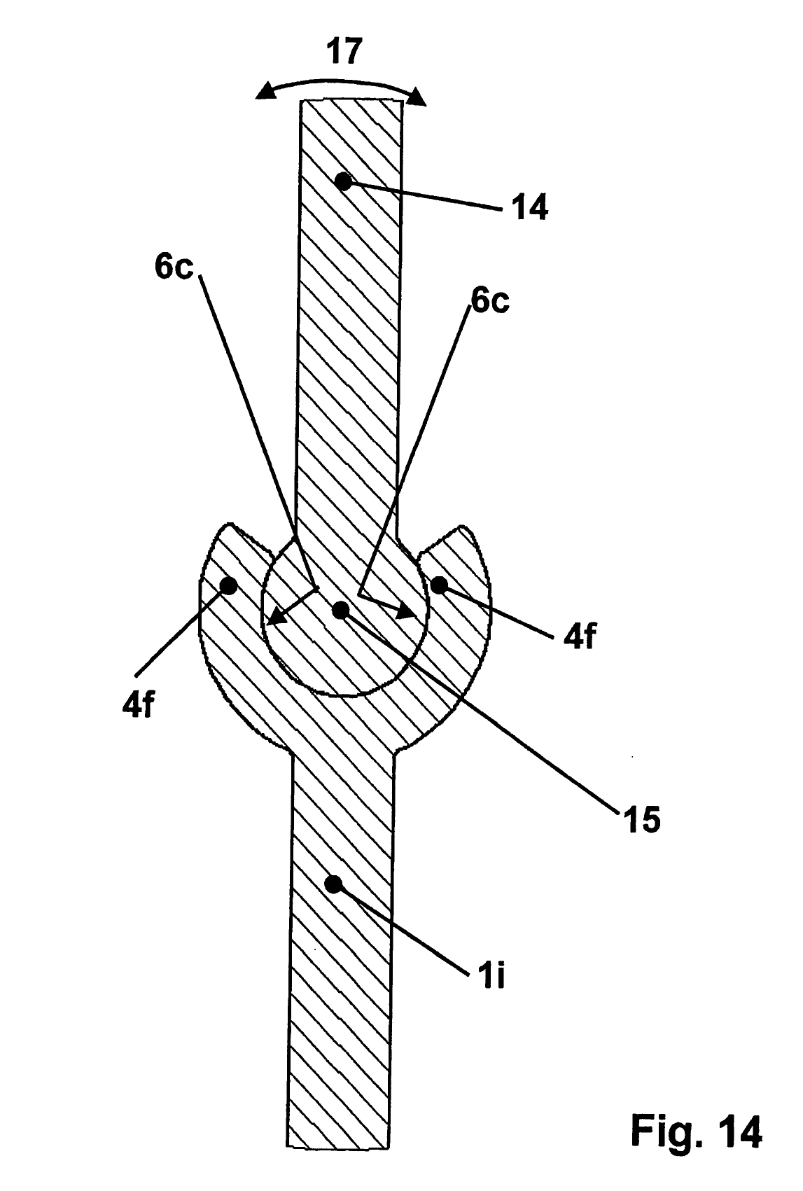

In FIG. 14, a pivoting guiding operation.

The longitudinal guiding operation shown in partial cross-section in FIG. 1 comprises two profiled guiding elements 1, between which are arranged rolling bodies 2 in the form of spheres. The two profiled guiding elements 1 are made of sheet metal on each of whose longitudinal edge 3, shown respectively in FIG. 1, two projecting edge flanges 4 that are approximately Y-shaped in cross-section are embodied. The edge flanges 4 are manufactured according to the gap profiling process known from document DE 100 39 768 A1. The surface area 5 lying between the two edge flanges 4 forms the guiding surface 7 for the rolling bodies 2, while the interior sides 6 of the two edge flanges 4 facing each other have no contact with the rolling bodies 2. The guiding surface 7 is strain-hardened by the rolling process taking place there during gap profiling and therefore exhibits increased toughness and hardness as well as an especially high-quality surface. These properties have a favorable effect with regard to the strains and wear occurring on such guiding operations.

The embodiment example according to FIG. 2 differs from the example according to FIG. 1 only in that the rolling bodies 2 are larger in diameter and consequently the size of the guiding surface 7 of the profiled guiding element 1 for the rolling bodies 2 is enlarged. The profiled guiding element 1a has, in the surface area 5a lying between the edge flanges 4, no contact with the rolling bodies 2. In contrast, in the surface areas 7a of the edge flanges 4 of the profiled guiding element 1a, two guiding surfaces for the rolling bodies 2 are formed. The position and size of the guiding surfaces 7a are defined by the geometric design of the profiled guiding element 1a, which can be influenced by the design of the geometries and positions of the rollers during gap profiling according to DE 100 39 768 A1, and the size of the rolling bodies 2. The flange surface 6 is strain-hardened by the rolling process taking place there during gap profiling and therefore exhibits increased toughness and hardness as well as an especially high-quality surface. These properties have a favorable effect with regard to the stains and wear occurring on such guiding operations.

The embodiment example according to FIG. 3 differs from the example according to FIG. 1 only in that one of the two profiled guiding elements 1 is replaced by a sheet-metal track 9 in which a groove 13 is embodied that forms a running surface for the rolling bodies 2.

The embodiment example according to FIG. 4 differs from the example according to FIG. 1 only in that one of the two profiled guiding elements 1 is replaced by a sheet-metal track 9a, in which the longitudinally oriented depression 13a that forms a running surface for the rolling bodies 2 is integrated.

In the embodiment example according to FIG. 5, two longitudinal guiding operations next to each other are configured, each of which exhibits one profiled guiding element 1 of the embodiment already described above in FIG. 1. Here, each profiled guiding element 1 forms, between its two edge flanges 4, the guiding surface for the rolling bodies 2 embodied as spheres. The other guiding paths 7b that work together with the rolling bodies 2 are formed, respectively, by partial areas of the interior sides 6a facing each other of the edge flanges 4a of the profiled guiding element 1b.

The embodiment example according to FIG. 6 differs from the example according to FIG. 5 only in that in partial areas of the interior sides 6c facing each other of the edge flanges 4b of the profiled guiding element 1c, longitudinally oriented depressions 10 are incorporated that serve as guiding surfaces 7c for the rolling bodies 2.

The embodiment example according to FIG. 7 differs from the example according to FIG. 5 only in that only one guiding surface 7b of the profiled guiding element 1b working together with the rolling body 2 is formed from a partial area of the interior sides 6a facing each other of the edge flanges 4a of the profiled guiding element 1b. The second guiding surface 7d of the profiled guiding element 1b working together with the rolling body 2a is formed by a partial area of the longitudinal edge 3a of the profiled guiding element 1b.

The embodiment example according to FIG. 8 is embodied with three longitudinal guiding operations. Here, in each one, each profiled guiding element 1 forms one respective guiding surface for the rolling bodies 2, 2a or 2b. The profiled guiding element 1b forms three guiding surfaces 7b, 7d and 7e, whereby the guiding surface 7b is formed in the area of the surfaces 6a of the edge flange 4a facing each other. In the area of the longitudinal edge 3a of the profiled guiding element 1b, two guiding surfaces 7d and 7e are embodied, whereby one guiding surface 7d is embodied in one radial area, produced by gap profiling, of the longitudinal edge 3a in the area of transition to the edge flange 4a. Another guiding surface 7e is embodied as depression 10a, and is embodied in the area of the longitudinal edge 3a of the edge flange 4e.

In the embodiment example according to FIG. 9, a guiding surface 7b working together with the rolling body 2 is formed in a partial area of the edge flange 4a of the profiled guiding element. The second edge flange 4c has been worked at the separating surface 11 by at least one manufacturing operation and shortened. Separating partial areas of at lease one edge flange 4c makes it possible to create construction space for guiding operations required by the construction design, resulting in highly flexible installation possibilities. Alternatively, it is also conceivable that manufacturing operations be used to alter the cross-sectional geometry of one or both edge flanges 4a and/or 4c.

Examples of such manufacturing operations are processes involving rolling, bending, and machining. Also conceivable is the insertion of recesses in the edge flanges 4b, 4e by means of punching, milling, and/or boring operations.

In the area of the longitudinal edge 3a of the profiled guiding element 1e, an additional guiding surface 7e for the rolling bodies 2a is embodied in the form of a depression 10a.

The embodiment example according to FIG. 10 shows a profiled guiding element 1f where three guiding surfaces 7c working together with the rolling bodies 2 are embodied in partial areas of the edge flanges 4g. The profiled guiding elements 1 form three additional guiding surfaces for the rolling bodies 2. In the profiled guiding element 1f, the edge flanges 4g were worked by means of manufacturing operations, whereby they were, firstly, bent and depressions were inserted in the area of the guiding surfaces 7c.

In the guiding operation shown in FIG. 11 in partial cross-section, partial areas of a profiled guiding element 1b form two guiding surfaces 7b for two rolling bodies 2. A sheet-metal rail 9b forms in partial areas two additional guiding surfaces 13 for the rolling bodies 2.

In the guiding operation shown in FIG. 12 in partial cross-section, partial sections of the edge flanges 4d of a profiled guiding element 1g have again been reshaped by means of gap profiling known from DE 100 39 768 A1 into nearly Y-shaped projecting additional edge flanges 4i. Here, partial areas 7 of the additional edge flanges 4i form the guiding surfaces for four rolling bodies 2. Further guiding surfaces for the rolling bodies 2 are formed by partial areas of a sheet-metal rail 9c. Recesses 12 and 12a are inserted in both the profiled guiding element 1g and in the sheet metal rail 9c that can be used for attaching the profiled guiding element 1g and/or the sheet metal track 9c to other components.

For example, the guiding operation shown can be placed in motor vehicles in the area of seat guiding operations.

In the guiding operation shown in FIG. 13 in a partial cross-section, partial areas of the edge flanges 4a, 4c, 4f and 4h of the profiled guiding element 1h form guiding surfaces for the rolling bodies 2. Here, the different lengths of the edge flanges 4f and 4h or 4a and 4c can be achieved by taking off partial areas of the edge flanges 4h and 4c. Alternatively, it is also possible to create asymmetrical lengths and cross-sectional geometries of the edge flanges 4a, 4c, 4f and 4h by defined tool configurations during the gap profiling process (DE 100 39 768 A1). Additional guiding surfaces for the rolling bodies 2 are formed by partial areas of a sheet metal rail 9d.

While the guiding operations described thus far are longitudinal guiding operations, FIG. 14 shows a pivoting guiding operation in partial cross-section. The two edge flanges 4f of the profiled guiding element 1i grip in a pivoting manner a sliding body 15 that forms an internal joint element. The interior sides 6c facing each other of the two edge flanges 4f form the guiding surface and lie on a common surface of a cylinder that also forms the exterior surface of the internal joint element 15. A component 14 integrally connected in one piece with the internal joint element 15, for example, can thus pivot with respect to the profiled guiding element 1i in the manner indicated by the arrows 17.

The internal joint element 15 can also be embodied on the longitudinal edge of the profiled guiding element 1i facing away from the edge flanges 4f For example, it is possible for a jalousie consisting of sheet steel lamellas that will exhibit a high degree of hardness and cannot be broken into to be manufactured from such intermeshing articulated profiled guiding elements.

The semi-finished product used in the manufacturing of the profiled guiding elements described in FIGS. 1 to 14 is sheet metal (sheet bar or from coil) consisting of any material suited to the purpose. If the exterior sides 3a—as for instance in the example according to FIG. 7—are called on to serve as guiding surfaces, any longitudinal channels that may have come about there during manufacturing can be adjusted by the proper selection of manufacturing process parameters.

The rolling bodies 2, 2a or 2b are shown in FIG. 1-13 in spherical form, but elliptical, cylindrical or other rolling bodies with a rotationally symmetrical cross-section could also conceivably be used.

In the embodiment examples of longitudinal guiding operations shown in FIGS. 1-8 and FIGS. 10-12, and in the example of a pivoting guiding operation according to FIG. 14 as well, the edge flanges 4a, 4b, 4d, 4e, 4f, 4g, 4h or 4i are arranged symmetrically to a plane 8 in the middle of the profiled guiding element 1, 1a, 1b, 1c, 1d, 1f, 1g, 1h or 1i. However, according to the gap profiling process described in DE 100 39 768 A 1, it is also possible for the edge flanges 4a, 4b, 4d, 4e, 4f, 4g, 4h or 4i to be designed with different lengths and cross-sectional dimensions.

It is possible, furthermore, for the longitudinal guiding operations described in FIGS. 1-13 to be embodied as sliding guiding operations, whereby no rolling bodies 2, 2a, 2b or 2c are used, but surface areas of the profiled guiding elements 1, 1a, 1b, 1c, 1d, 1e, 1f, 1g or 1h form at least one sliding guiding operations by making contact with other surface areas of profiled guiding elements 1, 1a, 1b, 1c, 1d, 1e, 1f, 1g or 1h, or with surface areas of sheet metal elements 9, 9a, 9b, 9c or 9d. To that end, lubricants can be used between the points of contact, and/or wear-reducing and/or friction-reducing surface coatings can be applied to the contact surfaces. It is also conceivable to use sliding bodies, such as polymer boards for example, instead of the rolling bodies 2, 2a or 2b described in FIGS. 1-13.

1-12. (canceled)

13. Profiled guiding element consisting of sheet metal for guiding operations, comprising at least one guiding surface provided thereon, wherein the profiled guiding element comprises two projecting edge flanges on a longitudinal edge that are formed by profiling gaps in the longitudinal edge, and at least one surface of the profiled guiding element forms a guiding surface for at least one rolling body or sliding body.

14. Profiled guiding element according to claim 13, wherein at least one surface of the edge flanges forms the guiding surface for the at least one rolling body or sliding body.

15. Profiled guiding element according to claim 14, wherein the surface area lying between the two edge flanges and/or a partial area of the interior-sides facing each other of the two edge flanges forms at least one guiding surface for at least one rolling body or sliding body.

16. Profiled guiding element according to claim 14, wherein the surface area lying between the two edge flanges at least partially forms the guiding surface.

17. Profiled guiding element according to claim 14, wherein the interior sides facing each other of the two edge flanges at least partially form guiding surfaces.

18. Profiled guiding element according to claim 14, wherein the guiding surface is cross-sectionally arc-shaped and works together with rolling bodies that are spherical in shape.

19. Profiled guiding element according to claim 14, wherein the two edge flanges are arranged symmetrically to a plane in the center of the profiled guiding element.

20. Profiled guiding element according to claim 14, wherein the two edge flanges are arranged asymmetrically to a plane in the center of the profiled guiding element.

21. Profiled guiding element according to claim 14, wherein the exterior side of at least one of the two edge flanges forms at least one guiding surface.

22. Profiled guiding element according to claim 14, wherein the two edge flanges at least partially grip, in a pivoting manner, a sliding body that forms an internal joint element.

23. Profiled guiding element according to claim 22, wherein both of the interior sides of the two edge flanges facing each other and forming the guiding surface lie on a common surface of a cylinder.

24. Profiled guiding element according to claim 13, wherein the guiding operations include at least one of longitudinal guiding operations and pivoting guiding operations.

25. Profiled guiding element according to claim 13, wherein the surface area lying between the two edge flanges and/or a partial area of the interior sides facing each other of the two edge flanges forms at least one guiding surface for at least one rolling body or sliding body.

26. Profiled guiding element according to claim 13, wherein the surface area lying between the two edge flanges at least partially forms the guiding surface.

27. Profiled guiding element according to claim 13, wherein the interior sides facing each other of the two edge flanges at least partially form guiding surfaces.

28. Profiled guiding element according to claim 13, wherein the guiding surface is cross-sectionally arc-shaped and works together with rolling bodies that are spherical in shape.

29. Profiled guiding element according to claim 13, wherein the two edge flanges are arranged symmetrically to a plane in the center of the profiled guiding element.

30. Profiled guiding element according to claim 13, wherein the two edge flanges are arranged asymmetrically to a plane in the center of the profiled guiding element.

31. Profiled guiding element according to claim 13, wherein the exterior side of at least one of the two edge flanges forms at least one guiding surface.

32. Profiled guiding element according to claim 13, wherein the two edge flanges at least partially grip, in a pivoting manner, a sliding body that forms an internal joint element.
